(19) United States
(12) Patent Application Publication
(10) Pub. No.: US 2008/0305257 A1
(43) Pub. Date: Dec. 11, 2008

(54) Device and Method for the Production of Stabilised Suspensions of Nanometric or Submicrometric Particles

(75) Inventors: Francois Tenegal, Paris (FR); Benoit Guizard, Creteil (FR)

Correspondence Address: THELEN LLP, P. O. BOX 640640, SAN JOSE, CA, 95164-0640, US

(73) Assignee: COMMISSARIAT A LENERGIE ATOMIQUE, PARIS (FR)

(21) Appl. No.: 12/097,243

(22) PCT Filed: Dec. 13, 2005
(86) PCT No.: PCT/FR05/51084

§ 371 Date: Jun. 12, 2008

(51) Int. Cl. B05D 7/00; B01J 23/00

(52) U.S. Cl. 427/217; 502/300; 422/261

(57) ABSTRACT

The invention relates a method for the production of stabilised suspensions of nanometric or submicrometric particles, which is a method contained in a continuous flow that includes a step (20) for the placing in suspension, dispersion and/or functionalisation of these particles produced in a gaseous stream containing the particles at the output of a reactor in a stream of at least one liquid.

The invention also relates a device that implements this method.

### CROSS REFERENCE TO RELATED APPLICATIONS OR PRIORITY CLAIM

This application is a national phase of International Application No. PCT/FR2005/051084, entitled “DEVICE AND METHOD FOR THE PRODUCTION OF STABILISED SUSPENSIONS OF NANOMETRIC OR SUBMICROMETRIC PARTICLES” which was filed on Dec. 13, 2005.

### TECHNICAL FIELD

The invention relates a device and a method for the production of stabilised suspensions of nanometric (<100 nanometre) or submicrometric (100±500 nanometre) particles.

In order to simplify the description in what follows, we will consider nanometric particles, or “nanoparticles”, by way of an example.

### STATE OF THE PRIOR ART

Industrial development of the products created from nanotechnologies and nanomaterials is expanding rapidly. This development is accompanied by the creation of industrial installations that are intended to mass-produce powders whose grain sizes are increasingly small. In this context, units for the production of nanometric particles, which are beginning to emerge currently, are tending to increase their production capacity rapidly.

The size of the particles is a factor that may strongly influence their toxicity. Thus certain phases thought to be inoffensive at the micrometric scale may become very toxic at the nanometric scale. The development of methods for the production of nanoparticles on an industrial scale may therefore prove to be dangerous if no precautions are taken in the light of the results of toxicological assessments, in order to protect the people supervising the production units or responsible for the handling and incorporation of these nanoparticles or for the environment.

The methods employed for the production of nanoparticles of the known prior art are many and varied. They can be divided into two categories: chemical methods producing the nanoparticles via the liquid route (sol-gel, coprecipitation, etc.) and the methods producing nanoparticles via the gas route (laser pyrolysis, plasma, combustion, evaporation condensation, etc.).

The methods via the liquid route produce nanoparticles directly in suspension in liquids. But these methods generally cannot be used to produce oxide nanoparticles.

The methods via the gas route produce carbide, nitride, oxide, metallic and composite nanoparticles. They therefore have greater flexibility than the methods via the liquid route. By way of an example, one can mention the Aerosil method (registered trademark) developed by the Degussa company, as described in the document referenced [1] at the end of the description, for the production of oxides of titanium, silicon and zirconium from the hydrolysis of metallic chlorides in flame. One can also mention the Physical Vapour Synthesis (PVS) method, developed by the Nanophase company for the synthesis of oxides by an evaporation-condensation process.

The devices for recovery of the nanoparticles operating with methods using the gas route (those in which the nanoparticles are produced in a gaseous stream) use recovery devices via the solid route, which generally include filtration barrier collectors that are used to stop the nanoparticles and allow the gases of the method to escape. Cyclone devices may also be used, as may electrostatic devices. The common point of all these devices is the method of recovery of the nanoparticles, which always comes down to a recovery method via the dry route. Thus, dry-route collection steps are always implemented when the collectors are full, in order to place the nanoparticles in a bag or container.

For the people with the aforementioned responsibilities, such steps then present a very high risk of exposure to nanoparticles. In fact, the collectors are then open and, due to the high volatility of the nanoparticles (often in agglomerate form), these are instantaneously put into suspension in the air (even in the slightest air stream) and may therefore be airborne to the entry routes into the human body (nostrils, mouth, ears, etc.).

One way of providing protection for the staff concerned consists of equipping the latter with sealed suits and breathing apparatus with a suitable means of filtration, or that operate by an air input obtained from an independent circuit. However such equipment constitutes a large additional cost (longer working times, purchase of suits, filters, etc.).

Moreover, due to their volatility, these nanoparticles may be deposited in various parts of the installations if no measures are adopted regarding their containment. This not only constitutes an additional risk for the staff responsible for cleaning but also for the environment (pollution of the water, the air, the ground, etc.). The containment resources to be installed also constitute an additional cost regarding both the design of the installations and their operation (replacement of filters, checks, and so on).

An additional risk arises when one is handling non-oxide nanoparticles, due to their high reactivity. Pyrophoric effects may be observed with metallic particles. These effects lead to the formation of oxide layers on the surface of the nanoparticles, which may limit the performance of the final products (such as the forming and the sintering of non-oxide nanopowders).

When the bagging or containerising has been completed, the nanoparticles are then introduced into a chain of processes that are designed to transform them with a view to obtaining a product with optimised properties (mechanical, thermal, electrical, magnetic, optical, etc.). The bags or containers are then opened and the same precautionary measures as mentioned previously are required, again leading to extra cost.

The fields in which such particles may be used are many and varied, and cover cosmetics, deposition processes, polishing applications, and use in catalysis or composites. These fields give rise to a requirement for suspensions of nanoparticles that are dispersed and stabilised. Dispersion via the liquid route may be obtained by the addition of dispersants that result in maximum repulsion of the particles by electrostatic and/or steric repulsion effects and by recourse to treatment using ultrasound. It is also possible, through suspension in liquids, to add new functions to the nanoparticles, such as by the precipitation of new inorganic phases on surfaces, or indeed by the grafting of organic molecules.

Thus the fact that the methods of the known prior art, of synthesis in the gaseous phase and then transformation of the nanoparticles, are decoupled represents a significant risk factor in view of the possible toxicity of these nanoparticles. In fact, the nanoparticles produced by the gaseous phase methods are often agglomerated, but the very low density of these agglomerates, especially in the case of the ceramic powders, confers upon them an extremely high volatility to such a degree as to facilitate ingestion and inhalation by people as well as contamination of the water, the ground and the air. Thus the methods of the known prior art, involving collection and transformation, necessitate the implementation of costly procedures and equipment in order to ensure the protection of people and to prevent contamination of the ground, the water and the air.

The object of the invention is a method for the production of suspensions of nanometric or sub-micrometric particles that enables us to overcome such drawbacks.

### DISCLOSURE OF THE INVENTION

The invention relates a method for the production of stabilised suspensions of nanometric or submicrometric particles, characterised in that this method is one that is contained in a continuous flow which includes a step for placing in suspension, dispersion and/or functionalisation of these particles produced in a gaseous stream at the output of a reactor in a stream of at least one liquid.

In a first embodiment, the placing in suspension of particles in the liquid is effected by bubbling. It is then possible to use a diffuser composed of a sleeve pierced with a multitude of holes that are used to maximise the exchange surface area between the gaseous stream and the liquid stream.

In a second embodiment the placing in suspension of particles in the liquid is effected by vaporising the liquid in the gaseous stream.

The dispersion of the particles takes place immediately after their placing in suspension. This dispersion may be brought about by means of at least one ultrasound emitter. This dispersion may also be effected using dispersants and/or surface-active agents that are injected in a stream into the flow of liquid before it is brought into contact with the gaseous stream of particles.

Functionalisation may include a deposition of metallic particles on the surface of oxide particles, this deposition being effected by impregnation of oxide particles by liquid precursors of precious metals. Deposition of the oxide particles may be followed by the impregnation of a catalytic medium by these oxide particles and then thermal treatment of the impregnated medium. Functionalisation may also include the generation, by co-precipitation, of mixed suspensions of particles, where these suspensions contain the chemical substances that will precipitate in the form of solid particles in the suspension.

After the placing in suspension, it is then possible to perform mixing by means of at least one helical mixer, or by a recirculating pump.

The method of the invention may use at least two devices for the production of stabilised suspensions of identical particles, operating in a manner that is offset and alternating.

The method of the invention may be coupled to.

a method for the production of a manufactured product that includes nanometric or submicrometric particles;

a method for the production of micrometric granules composed of nanometric particles.

The invention also relates a device for the production of stabilised suspensions of nanometric or submicrometric particles characterised in that it includes a reservoir with:

means for the insertion of a stream of particles by means of a diffuser,

means for the injection of at least one liquid into the upper part of this reservoir,

means for the removal of gases from the upper part of the reservoir following filtration means,

means for the dispersion of the particles,

means for the extraction of suspensions of particles.

Advantageously, the filtration means may include one or more very high efficiency (VHE) ceramic filters. The dispersion means may include an ultrasound emitter.

The invention also relates a device that includes two identical assemblies adapted to function in an offset and alternating manner, where each assembly includes:

at least one ceramic filter that is used to recover, via the dry route, the particles produced in a stream at the output of a reactor, while allowing the escape of a stream of gas via a pumping system,

first valves adapted to link or to isolate each assembly of the reactor and of the pumping system,

a second valve for removal of the suspensions produced in each assembly,

at least one ultrasound emitter.

The method of the invention has the advantage of avoiding any risk of disseminating nanoparticles into the environment, as well as any risk of ingestion and/or inhalation by the people responsible for the recovery of these nanoparticles. This method also has the advantage of being able to disperse and/or functionalise, and if necessary incorporate, the nanoparticles directly at the output of the production reactor, which therefore reduces the cost of the whole production chain, from synthesis of the particles to their incorporation.

### BRIEF DESCRIPTION OF THE DRAWINGS

FIG. 1 illustrates a method for the production of stabilised suspensions of nanoparticles of the known prior art.

FIG. 2 illustrates the method for the production of stabilised suspensions of nanoparticles of the invention.

FIGS. 3 and 4 illustrate a device for placing in suspension, and for dispersion in the waters of nanoparticles produced in a gaseous stream according to the invention.

FIG. 5 illustrates a variant embodiment of the device of the invention.

### DETAILED DESCRIPTION OF PARTICULAR EMBODIMENTS

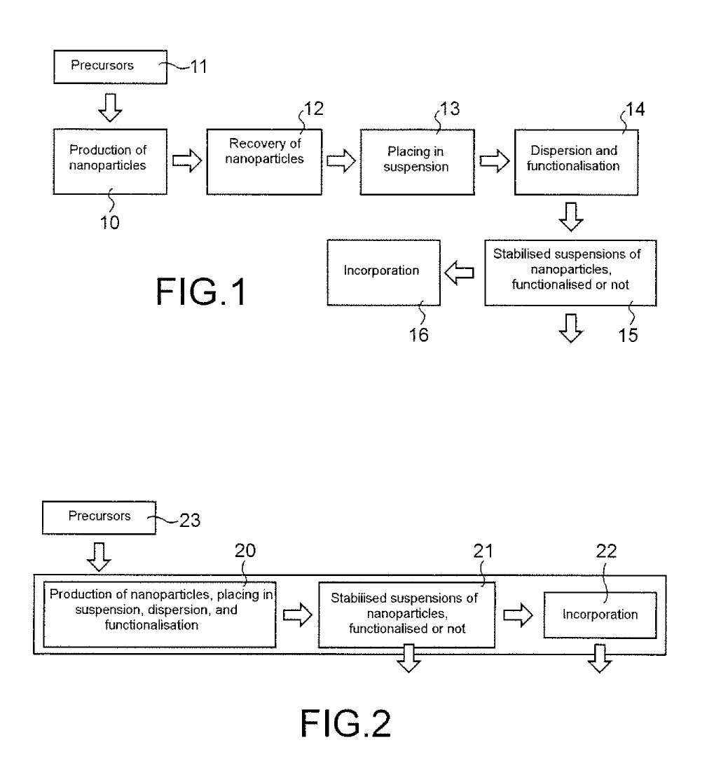

As illustrated in FIG. 1, a method for the production of stabilised suspensions of nanoparticles of the known prior art includes successive steps:

for the production of nanoparticles 10 from precursors 11,

for the recovery of nanoparticles 12, with a high risk of contamination,

for placing in suspension 13, with a high risk of contamination,

for dispersion and/or functionalisation 14, that allows us to obtain, from the stabilised suspensions 15, nanoparticles, functionalised or not, which may then be incorporated 16.

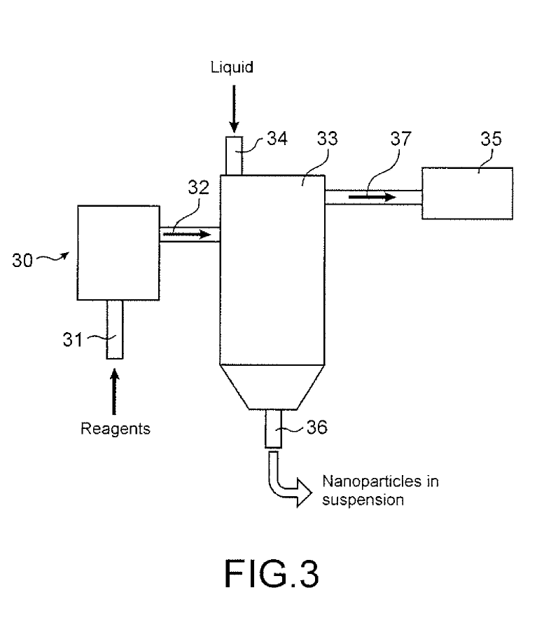

On the other hand, as illustrated in FIG. 2, the method for the production of stabilised suspensions of nanoparticles of the invention includes a step for placing in suspension, dispersion, and/or functionalisation 20 that also allows to obtain, from precursors 23, stabilised suspensions 21 of nanoparticles, functionalised or not, which may then be incorporated 22.

The method of the invention is a contained, continuous and single stream method, which allows the placing in suspension, dispersion and/or functionalisation, in at least one liquid, of a collection of nanoparticles produced in a gaseous stream at the output of a reactor.

The nanoparticles are produced by one or more synthesis methods in the gaseous phase (laser pyrolysis, plasma, evaporation-condensation, combustion, etc.). The method of the invention is coupled to such a synthesis method so that at no time are the particles brought into contact with the environment (air, water, or ground) or with people.

Advantageously, the concentration in nanoparticles of the suspensions produced may be changed as desired by increasing or reducing the liquid or gas flows.

The placing in suspension of the nanoparticles in the liquid stream may be achieved by bubbling and/or by vaporisation of the liquid in the gaseous stream containing the nanoparticles. In both cases, it is preferable to maximise the exchange surface area between the gaseous stream and the liquid stream. In the bubbling case, a diffuser, composed of a sleeve pierced with a multitude of holes, which effectively allows the exchange surface area between the gaseous stream containing the nanoparticles and the liquid stream to be maximised, can be used in order to maximise the quantity of nanoparticles placed in suspension per unit of time.

The dispersion of the nanoparticles in the liquids in which they are placed in suspension, which takes place immediately after they have been placed in suspension, may be effected by the use of one or more ultrasound emitters and/or by the use of dispersants and/or surface-active (functionalisation) agents. In the latter case, the dispersants or surface-active agents may be injected in a stream into the flow of liquid before it is brought into contact with the stream of nanoparticles.

Mixing of the suspension thus obtained may then be performed by means of one or more screw-type mixers or using a recirculating pump, which guarantee the homogeneity of this suspension.

Functionalisation is a step used to add an additional function to the surface of the nanoparticles (grafting of organic molecules, precipitation of inorganic phases, etc.) with a view to different applications (catalysis, biomedical, cosmetic, etc.). Functionalisation by specific molecules is employed in order to stabilise the state of dispersion of the suspension by the steric effect once the dispersion by ultrasound treatment had ended and thus prevent any re-agglomeration of the nanoparticles in the liquid.

A concrete example of functionalisation would be the deposition of metallic nanoparticles on the surface of oxide nanoparticles leads to the creation of a catalytic material. Such a deposition may be effected in situ by the impregnation of oxide nanoparticles by liquid precursors of precious metals, and may be followed by impregnation of a catalytic medium (a foam for example) and then thermal treatment of the impregnated medium.

Such a deposition may also be effected outside of the process.

Another example of functionalisation would be to generate, by precipitation (a known method for the synthesis of nanoparticles via the liquid route) of mixed suspensions of nanoparticles whose phases are well dispersed in relation to each other. The suspension of well dispersed nanoparticles then contains the chemical substances that will precipitate in the form of solid particles in the suspension.

The method of the invention therefore allows the placing in suspension, the dispersion and the functionalisation of particles in a single stage, by the use of suitable precursors.

The method of the invention may be coupled to equipment that allows transformation of these suspensions with the aim of creating a manufactured product that includes the nanoparticles of the suspension.

A device that allows implementation of the method of the invention may thus be connected at the output of equipment used for the continuous creation of nanostructured depositions by electrophoresis, by impregnation or indeed by plasma projection, for the creation “in situ” of nanostructured catalytic deposits for example. In fact the suspensions of oxide nanoparticles impregnated by metallic precursors may be injected continuously into an impregnation module for the purpose of impregnating suitable substrates and of directly producing a preform which, after thermal treatment, may be used to obtain a manufactured product that is usable directly in any desired application (i.e. using a single device).

Such a device may also be coupled to an atomisation-drying appliance in order to recover micrometric granules composed of the nanoparticles, either functionalised or not.

The method of the invention as described above is used to eliminate any risk factor that may exist for people and the environment. In fact, the nanoparticles are no longer collected via the dry route and then placed in suspensions. They are placed in suspension directly in suitable liquids. The conventional collection operations are eliminated. Moreover, the suspensions produced may be directly injected into devices that allow their transformation for the purpose of application (electrophoresis, thermal projection, etc.). The result is a significant increase in the productivity of the production chain of the method (synthesis, placing in suspension, dispersion, functionalisation, and incorporation) and, as a consequence, a large reduction in costs, especially labour costs. The method of the invention also allows elimination of the oxidation of non-oxide particles and the creation of suspensions of non-oxide nanoparticles that are uncontaminated by oxygen.

In the remainder of this description, we will consider, by way of an example, a device for the placing in suspension and dispersion, in an aqueous medium, of nanoparticles of TiO2, produced at the output of a laser pyrolysis reactor.

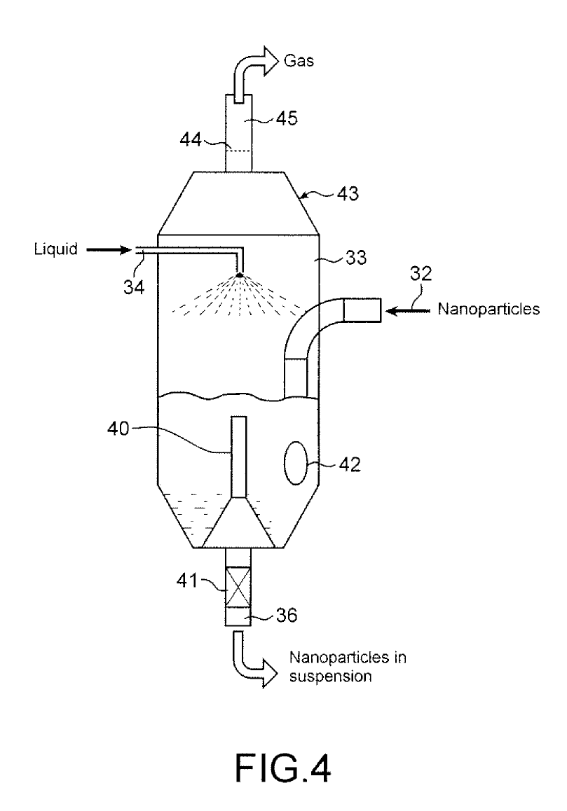

In the device of the invention, as represented in FIGS. 3 and 4, nanoparticles of TiO2 are produced in a continuous stream by laser pyrolysis of liquid titanium isopropoxide (Ti[OCH(CH₃)₂]4). The titanium isopropoxide is injected into a reactor 30 by means of an aerosol generator operating on the principle of ultrasound atomisation using air or argon as the carrier gas. The nanoparticles 32 are produced continuously at a production rate of 1 kg/h in a gaseous stream composed mostly of argon (2001/min.), which makes 5 grams of nanoparticles per litre of gas.

As illustrated in FIG. 3, the laser pyrolysis reactor 30, which receives reagents through an orifice 31 emits a stream of nanoparticles 32. It is connected directly to a device 33 into which a liquid is injected through an orifice 34, and which is connected to a pumping system 35 that allows placing in suspension and dispersion by ultrasound in the liquid, which may be water for example, of the nanoparticles 32 produced in the gaseous stream. The device 33 is composed of a receptacle with a maximum fill capacity of 50 litres of liquid.

As illustrated in FIG. 4, the stream of nanoparticles 32 is bubbled in the receptacle of the device 33 by means of a diffuser 42 composed of a ball that is pierced with a multitude of holes, 6 mm in diameter. The liquid is injected continuously through an orifice 34, and atomised into the upper part 43 of the device 33 which is used to perform the placing in suspension of ant residual nanoparticles present in the gas after the bubbling process. A stream of gas 37 is removed through an orifice 45 to the pumping system 35 in the upper part of the device 33 following a THE 44 ceramic filter. Immediately after they have been put into suspension, the nanoparticles are dispersed by means of an ultrasound emitter 40 that is immersed and placed at the centre of the device 33. The device 33 then delivers a stream of nanoparticles in suspension via an orifice 36. The injected liquid stream and the output suspension stream of the device 33 are identical, and are controlled by regulation valves 41.

At start-up, the device 33 remains static (no liquid stream) until the suspension reaches the desired concentration. In this present example, the suspension remains in static mode for 1 hour, corresponding to a charge of 2% of nanoparticles per litre of liquid. After two hours in static mode, the suspension is loaded to 4%, and so on.

After one hour of operation, the change to dynamic mode (to flow mode) is effected by the injection of liquid and removal of the suspension by opening the regulation valves 41. The flow is then 0.83 l/min, so as to keep the loading rate at 2%. We thus recover 0.83 litres of suspension loaded at 2% per minute at the output of the device.

The water used as the liquid has a pH of 4, thus stabilising the state of dispersion of the nanoparticles in the liquid. This pH was determined beforehand by measurements of the Zeta potential.

The device for the production of stabilised suspensions of nanoparticles illustrated in FIG. 4 is therefore adapted to produce dispersed suspensions of TiO2 nanoparticles in a continuous stream. The device is used to effect the placing in suspension of TiO2 nanoparticles produced in the gaseous stream 32 at the output of the reactor 30 operating in the gaseous phase by bubbling of a liquid stream.

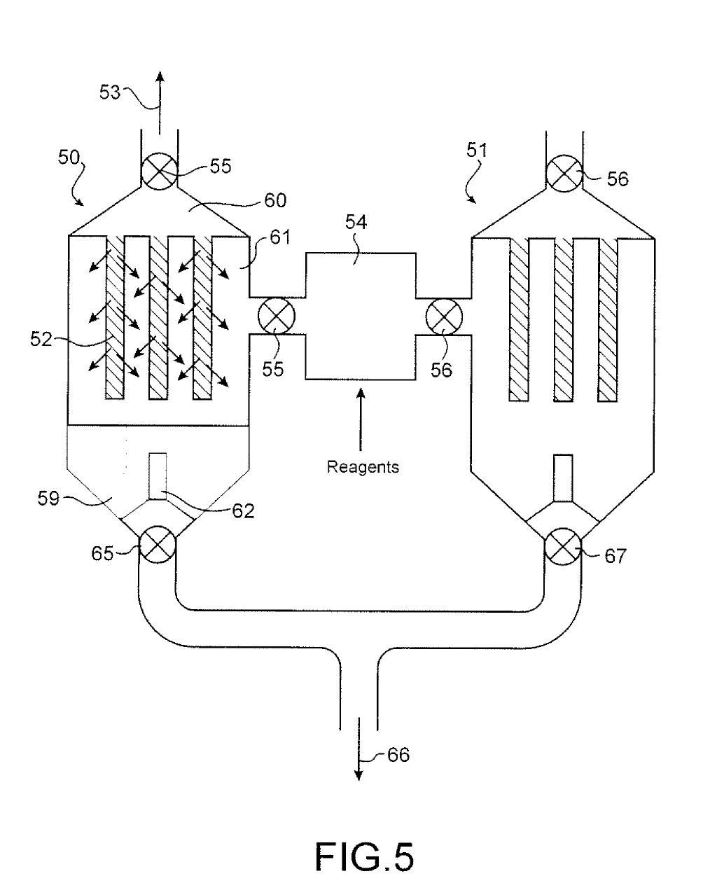

In the case where there is incompatibility between the liquid and the gas produced by the method, a variant embodiment, illustrated in FIG. 5, may be used.

This variant uses at least two devices for the production of stabilised suspensions of nanoparticles which are identical 50, 51 and operate in an offset and alternating manner.

In a first step, a first device 50, using ceramic filters 52, is used to recover, via the dry route, the nanoparticles produced in a gaseous stream at the output of the reactor 54 while allowing the escape of a stream of gas 53 to a pumping system. Once the maximum recovery capacity of the filters 52 of this first device 50 has been reached, this device 50 is isolated from the reactor 54 and from the pumping system by closure of valves 55 while the second device 51 is connected to the reactor 54 and to the pumping system by opening of valves 56, so that it may fill up in its turn. During the filling of the second device 51, the bottom of the first device 50 is filled with a liquid 59, in which it is desired to place in suspension, disperse and functionalise the nanoparticles. The sheets of powder deposited on the surface of the filters 52 of the first device 50 are then detached by injecting a gas 60 into this device 50 so as to create an output stream 61 at the filters 52 flowing in the reverse direction in relation to that of the step for recovery via the dry route. The sheets thus failing in the liquid are then dispersed by at least one ultrasound emitter 62 immersed in the liquid at the bottom of the device. After placing in suspension of the nanoparticles, as effected in the device illustrated in FIG. 4, and after any desired functionalisations, the suspensions thus produced are removed to the equipment for transformation of the suspensions by the opening of a valve 65. When this removal process has ended, the valve 65 is closed and the first device 50 is again connected to the reactor 54 and to the pumping system by the opening of valves 55, so that the recovery via the dry route in the filters 52 of the first device 50 can resume. The second device 51 is then isolated by closure of valves 56 for the step for placing in suspension, dispersion, and functionalisation in the same manner as that effected in the first device 50.

Using such a variant with two devices 50, 51, the gases of the method are never brought into contact with the liquid in which it is desired to place the nanoparticles in suspension. At the output of the two devices 50, 51, we then produce the suspensions of nanoparticles in a continuous stream, as in the case of the device illustrated in FIG. 4.

1. A method for the production of stabilised suspensions of nanometric or submicrometric particles, wherein this method is one that is contained in a continuous flow which includes a step for the placing in suspension, dispersion and/or functionalisation of these particles produced in a gaseous stream containing the particles, at the output of a reactor in a stream of at least one liquid.

2. The method according to claim 1, wherein the placing in suspension of particles in the liquid is effected by bubbling.

3. The method according to claim 2, wherein a diffuser, composed of a sleeve pierced with a multitude of holes, is used to maximise the exchange surface area between the gaseous stream and the liquid stream.

4. The method according to claim 1, wherein the placing in suspension of particles in the liquid is effected by vaporising the liquid in the gaseous stream.

5. The method according to claim 1, wherein the dispersion of the particles takes place immediately after their placing in suspension.

6. The method according to claim 5, wherein this dispersion is effected by means of at least one ultrasound emitter.

7. The method according to claim 5, wherein this dispersion is effected using dispersants and/or surface-active agents that are injected in a stream into the flow of liquid before it is brought into contact with the gaseous particle stream.

8. The method according to claim 1, wherein functionalisation includes the deposition of metallic particles in the surface of oxide particles.

9. The method according to claim 8, wherein this deposition is effected by impregnation of oxide particles with liquid precursors of precious metals.

10. The method according to claim 8, wherein the deposition of oxide particles is followed by the impregnation of a catalytic medium by these oxide particles and then thermal treatment of the impregnated medium.

11. The method according to claim 1, wherein functionalisation includes the generation by co-precipitation of mixed suspensions of particles, where these suspensions contain chemical substances that will precipitate in the form of solid particles in the suspension.

12. The method according to claim 1, wherein mixing is achieve by means of at least one screw-type mixer or a recirculating pump.

13. The method according to claim 1, which uses at least two devices for the production of stabilised suspensions of particles, which are identical and operate in an offset and alternating manner.

14. A method for the production of a manufactured product that includes nanometric or submicrometric particles that use the method according to claim 1.

15. A method for the production of micrometric granules composed of nanometric or submicrometric particles that use the method according to claim 1.

16. A device for the production of stabilised suspensions of nanometric or submicrometric particles, which includes at least one reservoir which includes:
means for the insertion of a stream of particles by means of a diffuser,
means for the injection of at least one liquid into the upper part of this reservoir,
means for removal of the gases into the upper part of the reservoir, following filtration means,
means for dispersion of the particles,
means for the outputting of particle suspensions.

17. The device according to claim 16, wherein the filtration means include at least one ceramic filter.

18. The device according to claim 16, wherein the dispersion means include an ultrasound emitter.

19. The device according to claim 16 that includes two identical assemblies, adapted to function in an offset and alternating manner, where each assembly includes:
at least one ceramic filter that is used to recover, via the dry route, the particles produced in a stream at the output of a reactor, while allowing the escape of a stream of gas to a pumping system,
first valves adapted to link or to isolate each assembly of the reactor and of the pumping system,
a second valve for removal of the suspensions produced in each assembly,
at least one ultrasound emitter.
